(19) United States
(12) Patent Application Publication
(10) Pub. No.: US 2014/0013352 A1
(43) Pub. Date: Jan. 9, 2014

(54) METHODS AND SYSTEMS FOR PROVIDING BROADCAST AD IDENTIFICATION

(71) Applicant: TVTAK LTD., Meitar (IL)

(72) Inventors: Adi Shavit, Mevasseret-Zion (IL); Dana Shavit, Mevasseret-Zion (IL)

(21) Appl. No.: 13/832,083

(22) Filed: Mar. 15, 2013

Related U.S. Application Data
(60) Provisional application No. 61/669,132, filed on Jul. 9, 2012.

(51) Int. Cl. H04N 21/8358

(52) U.S. Cl. CPC H04N 21/8358
USPC 725/34

(57) ABSTRACT

The present invention discloses methods and systems for providing broadcast ad identification. Methods include the steps of: providing fingerprint signatures of each frame in a broadcast video; and designating at least two repeat fingerprint signatures upon detecting at least one fingerprint-signature match from the signatures. Preferably, methods further include: prior to the designating, determining whether the fingerprint signatures correspond to a known ad based upon detecting at least one fingerprint-signature match of the fingerprint signatures with pre-indexed fingerprint signatures of pre-indexed ads. Preferably, method further include: creating segments of the fingerprint signatures, ordered according to a timeline temporal proximity of the fingerprint signatures, by grouping at least two fingerprint signatures based on a repeat temporal proximity of at least two repeat fingerprint signatures respective of at least two fingerprint signatures. Preferably, methods further include detecting at least one ad candidate based on an occurrence of at least one repeat segment.

### CROSS REFERENCE TO RELATED APPLICATIONS

This patent application is a continuation-in-part (CIP) of, and claims priority to, U.S. patent application Ser. No. 13/821,983, filed on Mar. 10, 2013, which therein claims priority under 35 U.S.C. §119(e) to U.S. Provisional Patent Application No. 61/469,875 filed Mar. 31, 2011, and under 35 U.S.C. §365(a) to PCT Patent Application No. IB2012/051584 filed Apr. 1, 2012, which are hereby incorporated by reference in their entirety.

This patent application further claims priority under 35 U.S.C. §119(e) to U.S. Provisional Patent Application No. 61/669,132 filed Jul. 9, 2012, which is hereby incorporated by reference in its entirety.

### FIELD AND BACKGROUND OF THE INVENTION

The present invention relates to methods and systems for providing broadcast ad identification. In particular, the present invention relates to systems that can identify when (i.e., in time and duration) and where (e.g., on which TV channel) each TV ad is broadcast.

Televised broadcast advertising has been a staple of consumer marketing and brand recognition for countless retailers since the advent of the television. Over the decades, while changing in content, TV ads have largely maintained a fairly-standard format. For numerous applications, the ability to accurately and precisely detect TV ads is considered to be valuable. However, the identification of TV ads from broadcasts is a task that is fraught with complexity. Adequate methods for detection are not known in the art.

In the art, US Patent Publication No. 2012/0114167 by Tian et al. (hereinafter referred to as Tian '167) discloses method for identifying repeat clip instances in video data by partitioning the data into ordered video units using content-based key-frame sampling, with each video unit having a sequence interval between two consecutive key-frames. The methods of Tian '167 create a fingerprint for each video unit, and group consecutive video units into time-indexed video segments in order to identify repeat clip instances based on correlation of the video segments.

The methods of Tian '167 are based on utilizing sequential frame similarity relying on multi-frame fingerprints, not the reoccurrence of single-frame fingerprints. The fingerprints are unit fingerprints of a segment. Such a “bottom-up” approach has inherent limitations with regard to frame-boundary issues, detection accuracy, and real-time detection.

Some important observations can be generally made regarding the nature of TV ads in comparison to the rest of the broadcasts that the ads are presented within. Ads obey a certain patterns that distinguish them from other broadcast video content.
(1) Ads are relatively short in duration (i.e., typically about 5-30 seconds)—distinguishing the ads from other longer video content, or from certain, very short, repeating slides or frames.
(2) Ads are repeatedly broadcast during the day—distinguishing the ads from show-specific video clips which may repeat (e.g., title sequences and re-entry excerpts from commercials), since TV shows are not broadcast throughout the day but are limited to a designated time slot.
(3) Ads are repeatedly broadcast at varying intervals during the day (i.e., there is a minimum time period between two broadcasts of an ad).
(4) Ads are broadcast on multiple channels—distinguishing the ads from channel and show promotion, since competing channels won't usually broadcast the same promotions.
(5) Ads typically appear within a batch of other commercials.

It would be desirable to have such methods and systems for providing broadcast ad identification. Such methods and systems would, inter alia, overcome the various limitations mentioned above utilizing the distinguishing ad characteristics mentioned above.

### SUMMARY OF THE INVENTION

It is the purpose of the present invention to provide methods and systems for providing broadcast ad identification.

In the interest of clarity, several terms which follow are specifically defined for use herein. The terms “video,” “video feed,” “TV feed,” “broadcast feed,” and “video clip” are used herein to refer to various technological embodiments of electronically processing and reconstructing a sequence of still images representing scenes in motion. The term “video server” is used herein to refer to a computer hardware system dedicated to run one or more video-feed services (detailed below) as a host in order to serve the needs of other components in the ad detection system of the present invention. The term “fingerprint signature” is used herein to refer to a compact representation of a frame of a video feed.

It is noted that the term “exemplary” is used herein to refer to examples of embodiments and/or implementations, and is not meant to necessarily convey a more-desirable use-case. Similarly, the term “preferred” is used herein to refer to an example out of an assortment of contemplated embodiments and/or implementations, and is not meant to necessarily convey a more-desirable use-case. Therefore, it is understood from the above that “exemplary” and “preferred” may be applied herein to multiple embodiments and/or implementations.

It is noted that a non-transitory computer-readable medium includes a hard drive, a compact disc, flash memory, volatile memory, non-volatile memory, and similar device memory, but does not include a transitory signal per se.

Preferred embodiments of the present invention enable recognition of TV ads that have not been previously detected, and therefore are not pre-indexed.

Other embodiments of the present invention enable recognition of TV ads. In preferred implementations of such embodiments, the system identifies in real time a commercial being broadcast. Utilizing the distinguishing ad characteristics mentioned above, the detection of repeating segments that aren't typically ads is enabled.

Such implementations enable revenue generation via real-time ad recognition, competitor analysis, and affiliate call-to-actions. Ad broadcast statistics including ad count, frequency, and time-of-day airing can be used in business-to-business (B2B) relationships. Real-time ad notification of an ad broadcast while it is being aired also provides enhanced B2B value.

Therefore, according to the present invention, there is provided for the first time a method for providing broadcast ad identification, the method including the steps of: (a) providing fingerprint signatures of each frame in a broadcast video for ad identification; and (b) designating at least two repeat fingerprint signatures upon detecting at least one fingerprint-signature match from the fingerprint signatures.

Preferably, the method further includes the step of: (c) prior to the step of designating, determining whether the fingerprint signatures correspond to a known ad based upon detecting at least one fingerprint-signature match of the fingerprint signatures with pre-indexed fingerprint signatures of pre-indexed ads.

Preferably, the method further includes the step of: (c) creating segments of the fingerprint signatures, ordered according to a timeline temporal proximity of the fingerprint signatures, by grouping at least two fingerprint signatures based on a repeat temporal proximity of at least two repeat fingerprint signatures respective of at least two fingerprint signatures.

More preferably, the method further includes the step of: (d) detecting at least one ad candidate based on an occurrence of at least one repeat segment.

Most preferably, the step of detecting at least one ad candidate is checked for consistency based on a segment-to-segment mapping.

According to the present invention, there is provided for the first time a system for providing broadcast ad identification, the system including: (a) a server including: (i) a CPU for performing computational operations; and (ii) a memory module for storing data; and (b) a processing module, residing on the server, configured for: (i) processing fingerprint signatures of each frame in a broadcast video for ad identification; and (ii) designating at least two repeat fingerprint signatures upon detecting at least one fingerprint-signature match from the fingerprint signatures.

Preferably, the processing module is further configured for: (iii) prior to the designating, determining whether the fingerprint signatures correspond to a known ad based upon detecting at least one fingerprint-signature match of the fingerprint signatures with pre-indexed fingerprint signatures of pre-indexed ads.

Preferably, the processing module is further configured for: (iii) creating segments of the fingerprint signatures, ordered according to a timeline temporal proximity of the fingerprint signatures, by grouping at least two fingerprint signatures based on a repeat temporal proximity of at least two repeat fingerprint signatures respective of at least two fingerprint signatures.

More preferably, the processing module is further configured for: (iv) detecting at least one ad candidate based on an occurrence of at least one repeat segment.

Most preferably, the detecting at least one ad candidate is checked for consistency based on a segment-to-segment mapping.

According to the present invention, there is provided for the first time a non-transitory computer-readable medium, having computer-readable code embodied on the non-transitory computer-readable medium, the computer-readable code including: (a) program code for processing fingerprint signatures of each frame in a broadcast video for ad identification; and (b) program code for designating at least two repeat fingerprint signatures upon detecting at least one fingerprint-signature match from the fingerprint signatures.

Preferably, the computer-readable code further includes: (c) program code for, prior to the designating, determining whether the fingerprint signatures correspond to a known ad based upon detecting at least one fingerprint-signature match of the fingerprint signatures with pre-indexed fingerprint signatures of pre-indexed ads.

Preferably, the computer-readable code further includes: (c) program code for creating segments of the fingerprint signatures, ordered according to a timeline temporal proximity of the fingerprint signatures, by grouping at least two fingerprint signatures based on a repeat temporal proximity of at least two repeat fingerprint signatures respective of at least two fingerprint signatures.

More preferably, the computer-readable code further includes: (d) detecting at least one ad candidate based on an occurrence of at least one repeat segment.

Most preferably, the program code for detecting at least one ad candidate includes program code for checking for consistency based on a segment-to-segment mapping.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified schematic diagram of the system architecture for providing broadcast ad identification, according to preferred embodiments of the present invention;

FIG. 2A is a simplified flowchart of the major process steps on a video server for providing broadcast ad identification, according to preferred embodiments of the present invention;

FIG. 2B is a simplified flowchart of the major process steps on an ad-candidate identification unit for providing broadcast ad identification, according to preferred embodiments of the present invention;

FIG. 2C is a simplified flowchart of the major process steps on an ad identification engine for providing broadcast ad identification, according to preferred embodiments of the present invention;

FIG. 2D is a simplified flowchart of the major process steps on an annotation site for providing broadcast ad identification, according to preferred embodiments of the present invention;

FIG. 3A is a simplified flowchart of the major process steps on a video server for providing broadcast ad identification, according to alternate embodiments of the present invention;

FIG. 3B is a simplified flowchart of the major process steps on an ad-candidate identification unit for providing broadcast ad identification, according to alternate embodiments of the present invention.

### DESCRIPTION OF THE PREFERRED EMBODIMENTS

The present invention relates to methods and systems for providing broadcast ad identification. The principles and operation for such methods and systems, according to the present invention, may be better understood with reference to the accompanying description and drawings.

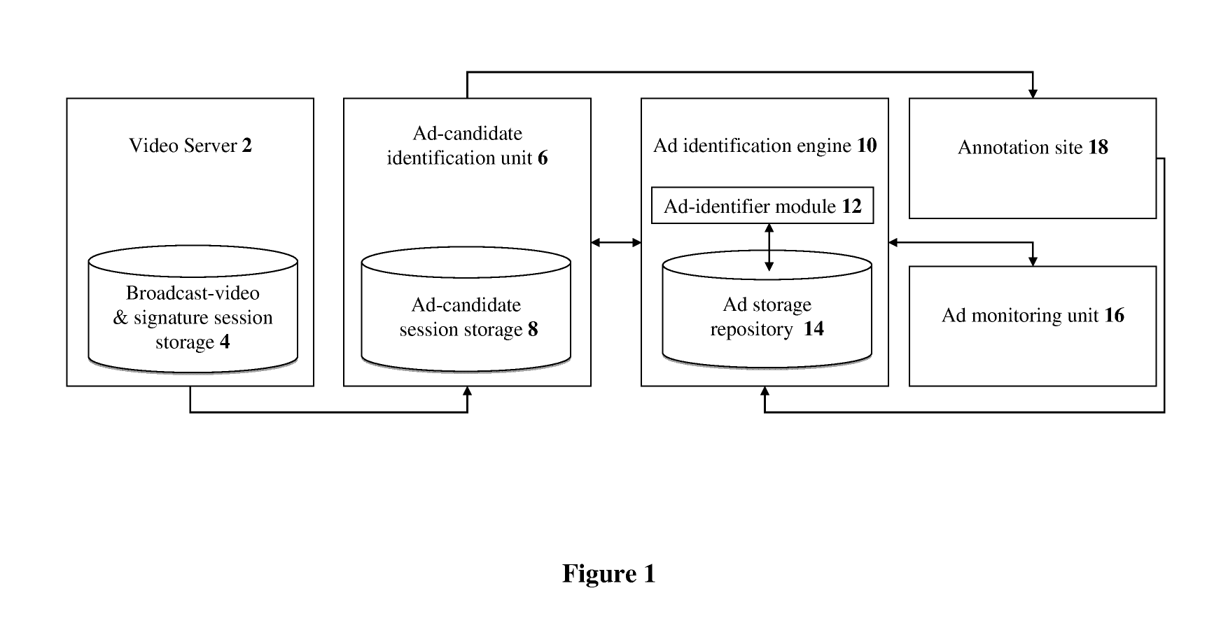

Referring now to the drawings, FIG. 1 is a simplified schematic diagram of the system architecture for providing broadcast ad identification, according to preferred embodiments of the present invention. A video server 2 is shown having a broadcast-video & signature session storage 4. The designation “session” is used herein to indicate that the storage of the bulk data is temporary. Once the bulk data of a session (e.g., a day's worth of video feeds) has been processed, the data will be removed to make room for the next session batch.

Video server 2 is operationally connected to an ad-candidate identification unit 6 having an ad-candidate session storage 8. Ad-candidate identification unit 6 automatically detects all new, unindexed ads, and extracts the ads as ad candidates for external tagging. Ad-candidate identification unit 6 processes in bulk from fingerprint session signatures.

Fingerprint signatures are computed from the TV feeds, and, optionally, relevant metadata is added to the fingerprint signatures. In such embodiments, fingerprint-signature comparison is performed using the well-known Hamming distance between bit-strings (i.e., the number of bits that are different between 2 bit-strings). The larger the Hamming distance is, the worse the match is between the signatures.

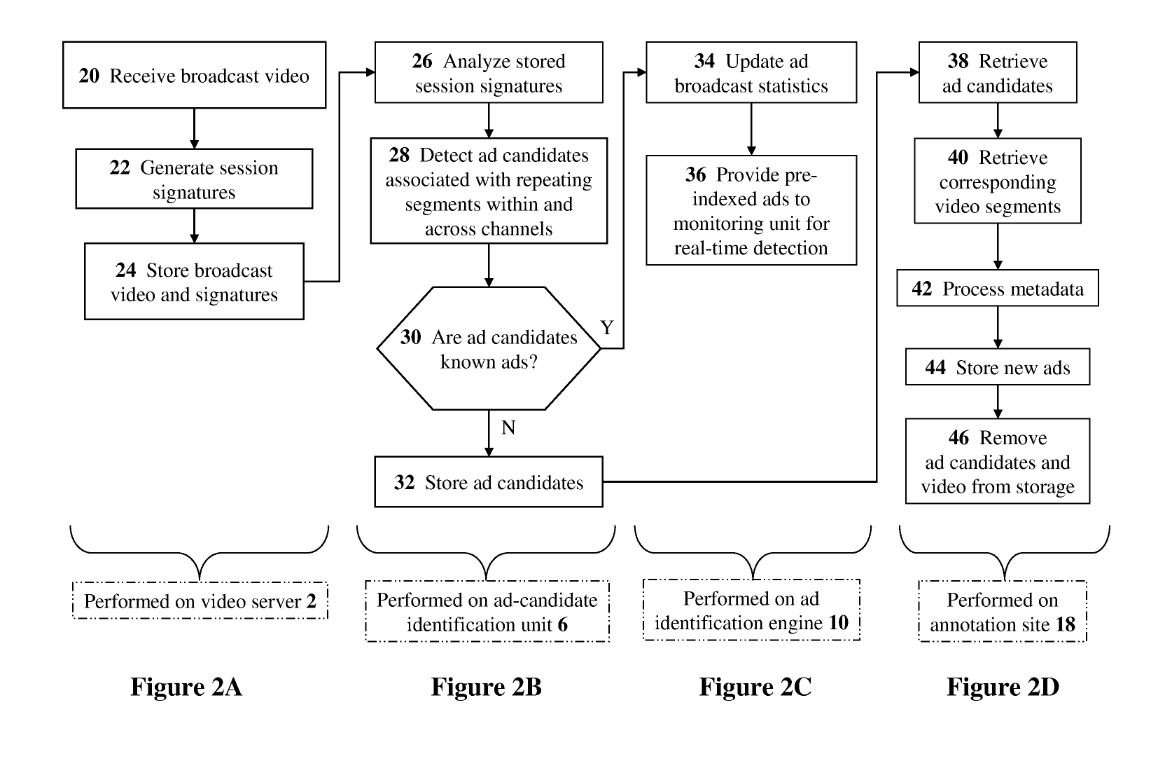

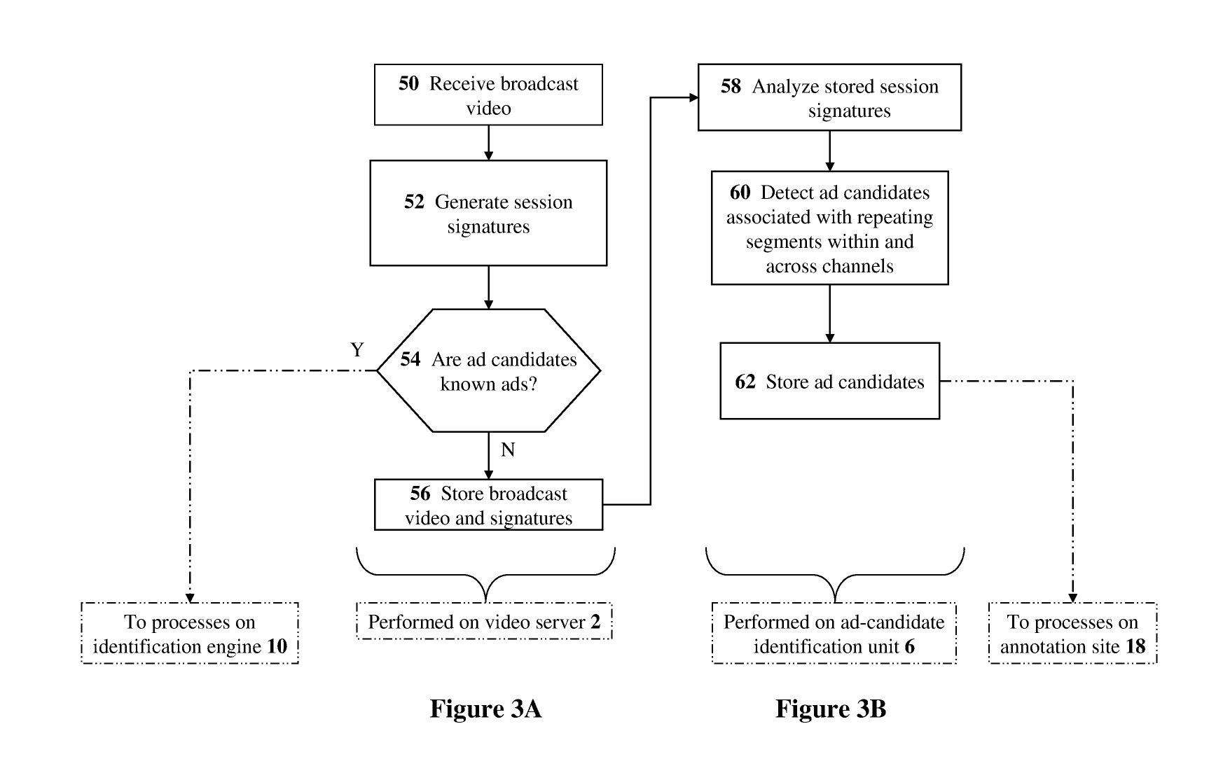

Bulk processing by ad-candidate identification unit 6 includes the processing of all sequential fingerprint signatures of multiple broadcast channels. Such bulk data of fingerprint signatures are required to be from a fairly-long duration of time (e.g., a day's worth of multi-channel broadcast feed) in order to identify ad candidates which have repeating elements. Processing can be performed on all the extracted fingerprint signatures (as described below with regard to FIG. 2B), or only on the fingerprint signatures corresponding to unidentified new content (as described below with regard to FIG. 3B).

Ad-candidate identification unit 6 is operationally connected to an ad identification engine 10 having an ad-identifier module 12 and an ad storage repository 14. Ad identification engine 10 is also operationally connected to an ad monitoring unit 16 which monitors all broadcast channels in real time, and detects the start and end of a known, pre-indexed ad (i.e., an ad that had previously been detected and tagged). Once a new, unindexed ad candidate is identified (and tagged at an annotation site 18 described below) as an ad by ad-candidate identification unit 6, the ad is added to ad storage repository 14, which allows the ad to be detected by ad monitoring unit 16 in real time. It is noted that in some implementations ad monitoring unit 16 resides on video server 2.

The ad-candidate extraction process employs a fingerprint-to-fingerprint (F2F) matching method. For each frame fingerprint signature, all—if any—matching fingerprint signatures (i.e., repeats) are found in the new session data in which ad identification engine 10 matches the bulk data to itself. Such operations need to be very fast and algorithmically efficient, since self-matching requires matching millions of fingerprint signatures to the same millions of fingerprint signatures.

For example, 24 hours of video, indexed at 15 frames/sec, generates 15×60×60×24=1.3 million fingerprint signatures. If matched naively against each other, such operations would require 1.3M×1.3M=1.678 billion signature comparisons. With a speedy 1 ms/comparison, more than 53 years of computing time would be required to complete the task.

Segments are then created by grouping together all consecutive fingerprint signatures which have repeats that are close together in time. The segment-creation process is sequentially performed over all fingerprint signatures. Fingerprint signatures are added to a current segment if the signatures' matches are close (in time) to the matches of previously-added fingerprint signatures in the current segment. If the signatures' matches aren't close to the matches of previously-added fingerprint signatures in the current segment, a new segment (having a new segment ID) is created. Fingerprint signatures with no matches are grouped into zero-segments.

The data is thus split into consecutive segments, with each segment being a sequence of consecutive fingerprint signatures. All fingerprint signatures possibly have matching fingerprint signatures in other segments. Since the segments are non-overlapping with no gaps between them, each fingerprint signature belongs to one and only one segment (and segment ID).

Optionally, a segment-to-segment (S2S) mapping method is then employed in which each segment is mapped to all other segments that contain matching fingerprint signatures to fingerprint signatures within a given segment. Mapping consistency is checked by creating a consistent S2S mapping that identifies true repeats for each segment. For each segment, all the other segments (IDs) that are from a different broadcast of the same video feed are found. Short segments are optionally removed. For each segment s, given N(s) is the set of neighboring segments previously mapped, all mapped segments t belonging to N(s) are then iterated. If s belongs to any of N(t), and the segment durations of s and t are similar, then the match between s and t is considered consistent—a type of bidirectional mapping.

Once all consistent repeating segments are found, the segments are classified using a segment filtering based on several segment types including:

(1) unique segments which appear only once;

(2) segments which repeat only on a single channel; and

(3) segments which repeat across multiple channels.

Ad-candidate identification unit 6 is also operationally connected to an annotation site 18, which is also operationally connected to ad identification engine 10. Annotation site 18 enables each ad candidate to be identified and tagged. Once the broadcast times, durations, and channels of all ad candidates are determined, each ad candidate is identified and tagged. Such identifying and tagging can be done manually by displaying the relevant video clip at the appropriate time to a user, and letting the user select the appropriate brand, and assign any relevant metadata to the clip.

Alternatively, such identifying and tagging can be done by using additional metadata associated with the video feed. Such additional metadata may include (but is not limited to):
(1) closed-caption text—often aired in-sync with the video feed, and which may contain brand names and other valuable ad information (in such a case, the video feed corresponding to the bulk data must be stored for the viewing process);
(2) speech-to-text—involving converting the audio track of the video feed into text, such captured text extracted from the video feed itself can contain valuable information and metadata (in such a case, there is no need to store the video feed itself, but only the additional metadata such as the audio track, the converted text, and/or the closed-caption text); and
(3) logo recognition—certain brands may be identified by automatic logo identification within a video feed.

Note that none of the identifying and tagging methods involving additional associated metadata allow for the precise extraction of the ad boundaries and repeats, nor are such approaches always feasible to perform in real time once an ad has been indexed.

Once an ad candidate has been identified and tagged, the ad candidate can be added to ad identification engine 10 for later identification in real time via ad-identifier module 12. All appearances of ads in the bulk data are also uploaded (retroactively) into ad statistics logs on ad identification engine 10.

FIG. 2A is a simplified flowchart of the major process steps on a video server for providing broadcast ad identification, according to preferred embodiments of the present invention. The process starts on video server 2 by receiving a broadcast video feed (Step 20). Session signatures are then generated (Step 22), and the broadcast video and signatures are stored in broadcast-video & signature session storage 4 (Step 24).

FIG. 2B is a simplified flowchart of the major process steps on an ad-candidate identification unit for providing broadcast ad identification, according to preferred embodiments of the present invention. The process starts when ad-candidate identification unit 6 receives the stored session signatures from video server 2. The stored session signatures are analyzed (Step 26), and ad candidates associated with repeating segments within and across channels are detected (Step 28). Ad-candidate identification unit 6 then determines whether the ad candidates are known ads (Step 30).

If the ad candidates aren't known ads, the ad candidates are stored in ad-candidate session storage 8 (Step 32). If the ad candidates are known ads, the ad candidates are transferred to ad identification engine 10.

FIG. 2C is a simplified flowchart of the major process steps on an ad identification engine for providing broadcast ad identification, according to preferred embodiments of the present invention. The process starts when ad-candidate identification unit 6 transfers the ad candidates that are known ads to ad identification engine 10. Ad identification engine 10 updates the ad broadcast statistics, stored in ad storage repository 14, and used by ad-identifier module 12 (Step 34). Ad identification engine 10 then provides the pre-indexed ad-identification service to ad monitoring unit 16 for real-time ad broadcast detection (Step 36).

FIG. 2D is a simplified flowchart of the major process steps on an annotation site for providing broadcast ad identification, according to preferred embodiments of the present invention. The process starts when the ad candidates are retrieved from ad-candidate identification unit 6 by annotation site 18 (Step 38). Corresponding video segments and/or additional metadata are retrieved (Step 40), and any metadata is processed (Step 42). The new ads are then stored (Step 44), and the ad candidates and video are removed from storage (Step 46).

FIG. 3A is a simplified flowchart of the major process steps on a video server for providing broadcast ad identification, according to alternate embodiments of the present invention. In alternate embodiments, video server 2 receives a broadcast video feed (Step 50). Session signatures are then generated (Step 52) as in the process of FIG. 2A. Video server 2 then determines whether the ad candidates are known ads (Step 54).

If the ad candidates aren't known ads, the ad candidates are stored in broadcast-video & signature session storage 4 (Step 56). If the ad candidates are known ads, the ad candidates are transferred to ad identification engine 10 for further processing as in FIG. 2C.

FIG. 3B is a simplified flowchart of the major process steps on an ad-candidate identification unit for providing broadcast ad identification, according to alternate embodiments of the present invention. The process starts when ad-candidate identification unit 6 receives the stored session signatures from video server 2. The stored session signatures are analyzed (Step 58), and ad candidates associated with repeating segments within and across channels are detected (Step 60) as in the process of FIG. 2B. The ad candidates are then stored in ad-candidate session storage 8 (Step 62), and the ad candidates are retrieved by annotation site 18 for further processing as in FIG. 2D.

While the present invention has been described with respect to a limited number of embodiments, it will be appreciated that many variations, modifications, and other applications of the present invention may be made.

What is claimed is:

1. A method for providing broadcast ad identification, the method comprising the steps of:
(a) providing fingerprint signatures of each frame in a broadcast video for ad identification; and
(b) designating at least two repeat fingerprint signatures upon detecting at least one fingerprint-signature match from said fingerprint signatures.

2. The method of claim 1, the method further comprising the step of:
(c) prior to said step of designating, determining whether said fingerprint signatures correspond to a known ad based upon detecting at least one fingerprint-signature match of said fingerprint signatures with pre-indexed fingerprint signatures of pre-indexed ads.

3. The method of claim 1, the method further comprising the step of:
(c) creating segments of said fingerprint signatures, ordered according to a timeline temporal proximity of said fingerprint signatures, by grouping at least two said fingerprint signatures based on a repeat temporal proximity of said at least two repeat fingerprint signatures respective of said at least two fingerprint signatures.

4. The method of claim 3, the method further comprising the step of:
(d) detecting at least one ad candidate based on an occurrence of at least one repeat segment.

5. The method of claim 4, wherein said step of detecting said at least one ad candidate is checked for consistency based on a segment-to-segment mapping.

6. A system for providing broadcast ad identification, the system comprising:
(a) a server including:
(i) a CPU for performing computational operations; and
(ii) a memory module for storing data; and
(b) a processing module, residing on said server, configured for:
(i) processing fingerprint signatures of each frame in a broadcast video for ad identification; and
(ii) designating at least two repeat fingerprint signatures upon detecting at least one fingerprint-signature match from said fingerprint signatures.

7. The system of claim 6, wherein said processing module is further configured for:
(iii) prior to said designating, determining whether said fingerprint signatures correspond to a known ad based upon detecting at least one fingerprint-signature match of said fingerprint signatures with pre-indexed fingerprint signatures of pre-indexed ads.

8. The system of claim 6, wherein said processing module is further configured for:
(iii) creating segments of said fingerprint signatures, ordered according to a timeline temporal proximity of said fingerprint signatures, by grouping at least two said fingerprint signatures based on a repeat temporal proximity of said at least two repeat fingerprint signatures respective of said at least two fingerprint signatures.

9. The system of claim 8, wherein said processing module is further configured for:
(iv) detecting at least one ad candidate based on an occurrence of at least one repeat segment.

10. The system of claim 9, wherein said detecting said at least one ad candidate is checked for consistency based on a segment-to-segment mapping.

11. A non-transitory computer-readable medium, having computer-readable code embodied on the non-transitory computer-readable medium, the computer-readable code comprising:
(a) program code for processing fingerprint signatures of each frame in a broadcast video for ad identification; and
(b) program code for designating at least two repeat fingerprint signatures upon detecting at least one fingerprint-signature match from said fingerprint signatures.

12. The computer-readable medium of claim 11, the computer-readable code further comprising:
(c) program code for, prior to said designating, determining whether said fingerprint signatures correspond to a known ad based upon detecting at least one fingerprint-signature match of said fingerprint signatures with pre-indexed fingerprint signatures of pre-indexed ads.

13. The computer-readable medium of claim 11, the computer-readable code further comprising:
(c) program code for creating segments of said fingerprint signatures, ordered according to a timeline temporal proximity of said fingerprint signatures, by grouping at least two said fingerprint signatures based on a repeat temporal proximity of said at least two repeat fingerprint signatures respective of said at least two fingerprint signatures.

14. The computer-readable medium of claim 13, the computer-readable code further comprising:
(d) detecting at least one ad candidate based on an occurrence of at least one repeat segment.

15. The computer-readable medium of claim 14, wherein said program code for detecting said at least one ad candidate includes program code for checking for consistency based on a segment-to-segment mapping.
